(19) United States
(12) Patent Application Publication
(10) Pub. No.: US 2022/0172241 A1
(43) Pub. Date: Jun. 2, 2022

(54) SYSTEM, METHOD, AND COMPUTER-READABLE MEDIUM INCLUDING PROGRAM FOR PROVIDING VIDEO DISTRIBUTION SERVICE

(71) Applicant: DeNA Co., Ltd., Tokyo (JP)

(72) Inventor: Kazuto Shibata, Tokyo (JP)

(73) Assignee: DeNA Co., Ltd., Tokyo (JP)

(21) Appl. No.: 17/537,763

(22) Filed: Nov. 30, 2021

(30) Foreign Application Priority Data
Dec. 2, 2020 (JP) 2020-200178

(51) Int. Cl. G06Q 30/02; H04N 21/45

(52) U.S. Cl. CPC G06Q 30/0208; H04N 21/4532

(57) ABSTRACT

A video distribution server according to an embodiment of the present invention promotes the strengthening of the relationship between a distributor and a viewer. The server is communicably connected to a user terminal via a communication network, and provides a video distribution service for distributing and viewing a video to the user via the user terminal. The server determines the grade of the viewer for the distributor on the basis of the satisfaction status of the grade condition, and assigns a reward to the distributor on the basis of the grade of each of the plurality of viewers. Therefore, for example, the upgrade of the viewer is a direct benefit to the distributor and the distributor is motivated to strengthen the relationship with the viewer.

### CROSS-REFERENCE TO RELATED APPLICATIONS

The present application claims the benefit of Japanese Patent Application No. JP2020-200178, filed on Dec. 2, 2020, the content of which is incorporated herein in its entire by reference.

### TECHNICAL FIELD

The present invention relates to a system, a method, and a computer-readable medium including program for providing a video distribution service.

### BACKGROUND

Conventionally, various video distribution services for distributing video have been provided (see, for example, Japanese Patent Application Laid-Open No. 2019-022219). These services have introduced various mechanisms for strengthening the relationship between the distributor and the viewer (which can also be called “connection” or “bond”). For example, a parameter such as a rank that increases as the video of the corresponding distributor is viewed is set for each combination of a distributor and a viewer, and the strength of the relationship between the distributor and the viewer is visualized using the value of the parameter.

However, although the mechanism described above visualizes the strength of the relationship between the distributor and the viewer, it is not such a mechanism that strengthening the relationship with the viewer is direct benefit to the distributor. In other words, the conventional mechanism does not give the distributor sufficient motivation to strengthen the relationship with the viewer.

One of the objects of the embodiment of the present invention is to promote the strengthening of the relationship between the distributor and the viewer. Other objects of the embodiment of the present invention will become apparent by reference to the entire specification.

### SUMMARY

The system according to an embodiment of the present invention is a system including one or more computer processors. The one or more computer processors execute machine-readable instructions to perform determining a grade of each of a plurality of viewers with respect to a distributor of a video on the basis of at least a satisfaction status by each of the plurality of viewers of a grade condition corresponding to each of a plurality of grades; and assigning a reward to the distributor on the basis of at least the grade of each of the plurality of viewers with respect to the distributor.

A method according to an embodiment of the present invention is a method executed by one or more computers. The method includes determining a grade of each of a plurality of viewers with respect to a distributor of a video on the basis of at least a satisfaction status by each of the plurality of viewers of a grade condition corresponding to each of a plurality of grades; and assigning a reward to the distributor on the basis of at least the grade of each of the plurality of viewers with respect to the distributor.

A non-transitory computer-readable medium according to an embodiment of the present invention includes a program. The program causes one or more computers to execute determining a grade of each of a plurality of viewers with respect to a distributor of a video on the basis of at least a satisfaction status by each of the plurality of viewers of a grade condition corresponding to each of a plurality of grades; and assigning a reward to the distributor on the basis of at least the grade of each of the plurality of viewers with respect to the distributor.

Various embodiments of the present invention can promote the strengthening of the relationship between the distributor and the viewer.

### BRIEF DESCRIPTION OF THE DRAWINGS

FIG. 1 is a configuration diagram schematically showing a configuration of a network including a video distribution server 10 according to an embodiment of the present invention.

FIG. 2 is a block diagram schematically showing the functions of the video distribution server 10.

FIG. 3 is a diagram illustrating information managed in a user information table 411.

FIG. 4 is a diagram for explaining the rank.

FIG. 5 is a diagram illustrating information managed in a distribution management table 412.

FIG. 6 is a diagram illustrating information managed in a grade management table 413.

FIG. 7 is a diagram illustrating a top screen 60.

FIG. 8 is a diagram illustrating the display content of an individual display area 641.

FIG. 9 is a diagram illustrating the top screen 60 when “topic” is selected in a selection area 62.

FIG. 10 is a diagram illustrating the display content of the individual display area 642.

FIG. 11 is a diagram illustrating a distribution preparation screen 100.

FIG. 12 is a diagram illustrating a distributor screen 70.

FIG. 13 is a diagram illustrating a viewer screen 80.

FIG. 14 is a diagram illustrating an item selection screen 200.

FIG. 15 is a diagram for explaining each condition of a plurality of fan levels.

FIG. 16 is a diagram illustrating a viewer information display screen 300.

FIG. 17 is a diagram illustrating a condition satisfaction detail screen 400.

FIG. 18 is a flowchart illustrating processes executed by the server 10 when updating the rank.

FIG. 19 is a diagram illustrating the correspondence between the number of special fans and the distribution point bonus (magnification).

FIG. 20 is a diagram for explaining a rule for updating a rank meter value.

FIG. 21 is a diagram for explaining the correspondence between the updated content of the rank and the required rank meter value.

FIG. 22 is a flowchart illustrating processes executed by the server 10 when a diamond is assigned.

### DETAILED DESCRIPTION

Hereinafter, embodiments of the present invention will be described with reference to the drawings. In each drawing, the same or similar components may be labeled with the same reference numerals.

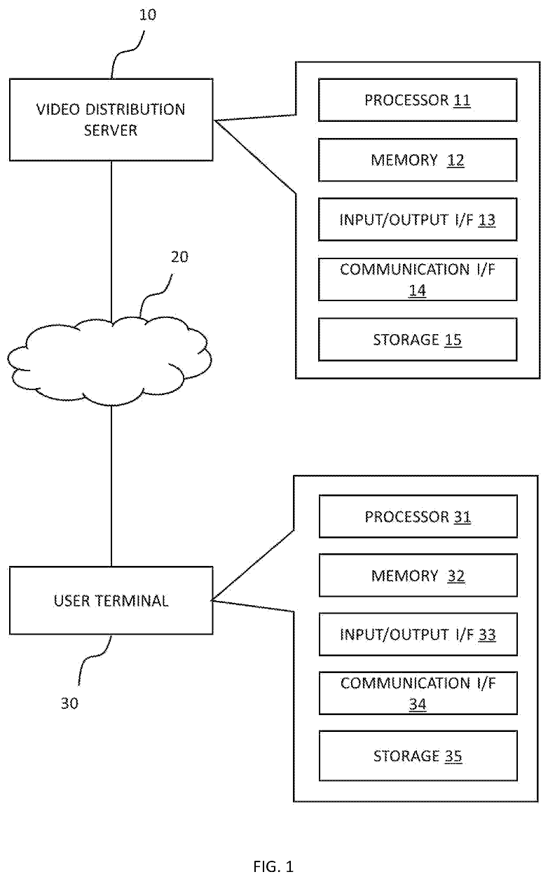

FIG. 1 is a configuration diagram schematically showing a configuration of a network including a video distribution server 10 according to an embodiment of the present invention. As shown in the drawing, the video distribution server 10 is communicably connected to a user terminal 30 via a communication network 20 such as the Internet. Although only one user terminal 30 is shown in FIG. 1, the server 10 is communicably connected to a plurality of user terminals 30. The server 10 provides a video distribution service for distributing and viewing a video to a user via the user terminal 30. In the present embodiment, the user who operates the user terminal 30 can distribute the video as a distributor, and can also view the video of another user as a viewer. The video distribution server 10 is an example of a device that implements a part or all of the system of the present invention.

First, the hardware configuration of the video distribution server 10 will be described. The video distribution server 10 is configured as a general computer, and as shown in FIG. 1, includes a computer processor 11, a main memory 12, an input/output I/F 13, a communication I/F 14, and a storage (storage device) 15, and these components are electrically connected via a bus or the like (not shown).

The computer processor 11 is configured as a CPU, a GPU, or the like, reads various programs stored in the storage 15 or the like into the main memory 12, and executes various commands included in the programs. The main memory 12 is configured of, for example, a DRAM or the like.

The input/output I/F 13 includes various input/output devices for exchanging information with an operator and the like. The input/output I/F 13 includes, for example, an information input device such as a keyboard and a pointing device (for example, a mouse, a touch panel, and the like), an audio input device such as a microphone, and an image input device such as a camera. Further, the input/output I/F 13 includes an image output device such as a display and an audio output device such as a speaker.

The communication I/F 14 is implemented as hardware such as a network adapter, various pieces of communication software, and a combination thereof, and is configured to realize wired or wireless communication via the communication network 20 or the like.

The storage 15 is configured of, for example, a magnetic disk, a flash memory, or the like. The storage 15 stores various programs including an operating system, various pieces of data, and the like.

In the present embodiment, the video distribution server 10 can be configured using a plurality of computers, each of which has the above-mentioned hardware configuration. For example, the video distribution server 10 may be configured of one or more server devices.

The video distribution server 10 configured in this way can be configured to have functions as a web server and an application server. In this case, the video distribution server 10 executes various processes in response to a request from the web browser and other applications (for example, a video distribution service application) installed on the user terminal 30, and transmits screen data (for example, HTML data) corresponding to the results of the processes, control data, and the like to the user terminal 30. The user terminal 30 may display a web page or other screens on the basis of the received data.

Next, the hardware configuration of the user terminal 30 will be described. The user terminal 30 is configured as a general computer, and as shown in FIG. 1, includes a computer processor 31, a main memory 32, an input/output I/F 33, a communication I/F 34, and a storage (storage device) 35, and these components are electrically connected via a bus or the like (not shown).

The computer processor 31 is configured as a CPU, a GPU, or the like, reads various programs stored in the storage 35 or the like into the main memory 32, and executes various commands included in the programs. The main memory 32 is configured of, for example, a DRAM or the like.

The input/output I/F 33 includes various input/output devices for exchanging information with an operator and the like. The input/output I/F 33 includes, for example, an information input device such as a keyboard and a pointing device (for example, a mouse, a touch panel, and the like), an audio input device such as a microphone, and an image input device such as a camera. Further, the input/output I/F 33 includes an image output device such as a display and an audio output device such as a speaker.

The communication I/F 34 is implemented as hardware such as a network adapter, various pieces of communication software, and a combination thereof, and is configured to realize wired or wireless communication via the communication network 20 or the like.

The storage 35 is configured of, for example, a magnetic disk, a flash memory, or the like. The storage 35 stores various programs including an operating system, various data, and the like. The program stored in the storage 35 can be downloaded and installed from an application market or the like.

In the present embodiment, the user terminal 30 can be configured as a smartphone, a tablet terminal, a personal computer, a wearable device, and the like.

The user who operates the user terminal 30 configured in this way can use the video distribution service provided by the server 10 by executing communication with the video distribution server 10 via a web browser or other applications installed in the storage 35 or the like.

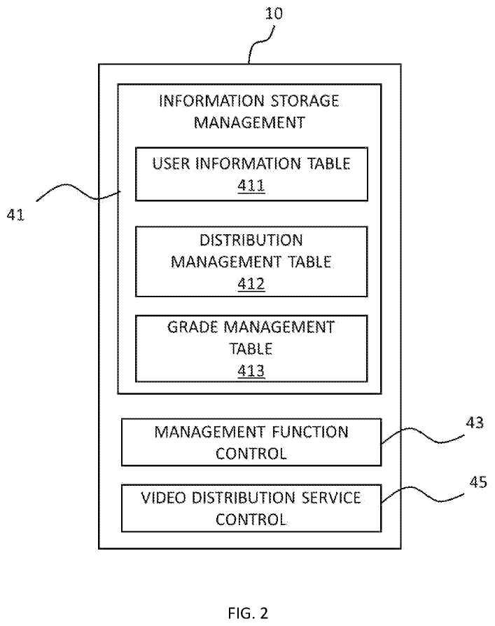

Next, the function of the video distribution server 10 configured in this way will be described. FIG. 2 is a block diagram schematically showing the functions of the video distribution server 10. As shown in the drawing, the server 10 has an information storage manager 41 that stores and manages various pieces of information, a management function controller 43 that controls the management function of the video distribution service, and a video distribution service controller 45 that controls the video distribution service. These functions are realized by the hardware such as the computer processor 11 and the main memory 12 and various programs and data stored in the storage 15 and the like operating in cooperation with each other. For example, the functions are realized by the computer processor 11 executing commands included in the program read into the main memory 12. Further, a part or all of the functions of the server 10 shown in FIG. 2 may be realized by the cooperation of the server 10 and the user terminal 30, or may be realized by the user terminal 30.

The information storage manager 41 is configured to store and manage various pieces of information in the storage 15 and the like. For example, as shown in FIG. 2, the information storage manager 41 has a user information table 411 that manages information on users of the video distribution service, a distribution management table 412 that manages information on individual video distribution, and a grade management table 413 that manages the grades of viewers for a distributor (individual distributors).

The management function controller 43 is configured to execute various processes related to the control of the management function of the video distribution service. For example, the management function controller 43 transmits screen data and control data of various screens related to the management function to the user terminal 30, executes various processes in responds to an operation input by the user via the screen displayed on the user terminal 30, and transmits screen data, control data, and the like corresponding to the results of the processes to the user terminal 30. The management function controlled by the management function controller 43 includes, for example, login processing (user authentication), billing control, user management (for example, updating of the user information table 411) and the like.

The video distribution service controller 45 is configured to execute various processes related to the control of the video distribution service. For example, the video distribution service controller 45 is configured to distribute the video provided by the distributor to a plurality of viewers. For example, in the case of real-time distribution (live distribution) of a video, the video distribution service controller 45 receives a real-time video transmitted from the user terminal 30 of the distributor (hereinafter, may be referred to as a “distributor terminal 30”) and transmits the video to the user terminals 30 of a plurality of viewers (hereinafter, may be referred to as “viewer terminals 30”). In the viewer terminal 30, the video is displayed (played) on the viewer screen for viewing the video. The real-time video is configured of, for example, an image input through the camera of the distributor terminal 30 and an audio input via a microphone. Further, the real-time video is configured of, for example, images and sounds output via an application (for example, a game application) running on the distributor terminal 30. Such a live distribution of video can be performed by, for example, a streaming method using a protocol such as HTTP Live Streaming (HLS). Further, the video distribution service controller 45 may be configured to record the video provided by the distributor in the information storage manager 41 (the storage 15 or the like), and distribute the video in response to individual requests from the viewers.

In the present embodiment, the video distribution service controller 45 is configured to determine the grade of the viewer with respect to the video distributor. The grade is determined on the basis of at least the viewer's satisfaction status of the grade conditions corresponding to each of a plurality of predetermined grades. For example, the video distribution service controller 45 determines the grade for a specific distributor, of a viewer who is viewing a video of the specific distributor, in real-time while this viewer views the video. Further, for example, the video distribution service controller 45 collectively determines the grades of each user as a viewer. Grades may be represented by other names such as ranks and levels.

Further, the video distribution service controller 45 is configured to give a reward to the distributor on the basis of at least the grade of each of the plurality of viewers for the distributor. For example, the reward for a distributor increases in value to the distributor as the viewer's grade for the distributor increases. The rewards include, for example, various electronic and virtual rewards that may be benefit to the distributor.

As described above, the video distribution server 10 in the present embodiment determines the grade of the viewer for the distributor on the basis of the satisfaction status of the grade condition, and gives a reward to the distributor on the basis of the grades of a plurality of viewers. Therefore, an increase in the grade of the viewer is direct benefit to the distributor, and the distributor is motivated to strengthen the relationship with the viewer. That is, the video distribution server 10 can promote the strengthening of the relationship between the distributor and the viewer.

In the present embodiment, the grade condition may include a condition that is satisfied according to the execution of an action by the viewer on the video of the distributor. Actions on the video include, but are not limited to, viewing the video, inputting comments, inputting items, inputting likes, and the like. Such a configuration can promote the viewer to perform an action.

In addition, the grade condition may include a condition that is satisfied according to the application of the regular charge by the viewer to the distributor. Regular charge (subscription) to a distributor is not limited to this, but is applied, for example, to enable a predetermined action (for example, inputting an item), which accompanies a charge, for the video of the distributor for a certain period of time. For example, the video distribution service controller 45 is configured to control the execution of an action by the viewer with respect to the video of the distributor, and the action is executed on the basis of individual charge or regular charge. For example, the video distribution service controller 45 causes a viewer to whom the regular charge is not applied to consume the corresponding quantity of paid items according to the execution of the action but does not cause a viewer to whom the regular charge is applied to consume a paid item according to the execution of the action. Such a configuration can promote the application of regular charge to viewers.

Further, the grade condition may be configured to vary on the basis of at least one of the distributor information on the distributor, the viewer information on the viewer, and the combination information on the combination of the distributor and the viewer. For example, the grade condition varies on the basis of the distributor's distribution history, level, area of residence, and the like. For example, the more beginner the distributor is, the more the grade condition is likely to be satisfied, and the grade is likely to increase. Further, for example, the grade condition varies on the basis of the viewer's viewing history, level, area of residence, and the like. For example, the viewer who lives in a specific residential area is more likely to be satisfied and the grade is more likely to increase. Further, for example, the grade condition varies on the basis of the viewing history of the viewer for the corresponding distributor's video, the relationship (presence of follow, and the like) between the distributor and the viewer, and the like. For example, the smaller the number of views of the viewer for the video of the corresponding distributor, the more the grade condition is likely to be satisfied, and the grade is likely to increase. Such a configuration can realize grade conditions according to individual circumstances.

In the present embodiment, the satisfaction status of the viewer's grade condition may be displayed on the viewer screen for viewing the video. For example, the viewer screen is configured to display the satisfaction status of the grade conditions of at least some of a plurality of viewers of the video (for example, a plurality of viewers viewing the video). For example, the viewer screen is configured to display the current grades of at least some viewers and the satisfaction status of the grade condition corresponding to the next (one higher) grade. Such a configuration allows the viewer to know the satisfaction status of the grade condition.

In this case, the viewer screen may be configured to display the satisfaction status of the grade condition of the viewer to which the viewer screen is presented in more detail than other viewers. That is, the viewer screen may be configured to display the satisfaction status of the grade conditions of the viewers other than the viewer to which the viewer screen is presented among the plurality of viewers of the video with a first detail level, while displaying the satisfaction status of the grade condition of the viewer to which the viewer screen is presented with a second detail level that is more detailed than the first detail level. The “detail level” referred to here is the degree of information given to the viewer on the satisfaction status of the grade condition. In one example, the higher the detail level, the higher the number of types or the larger the amount of information displayed to the viewer on the viewer screen. Such a configuration enables the viewer to know the details of the satisfaction status of the grade condition of the viewer himself/herself and to know the outline of the satisfaction status of the grade condition of other viewers.

In the present embodiment, the grade of each viewer may be managed at regular intervals. For example, the video distribution service controller 45 is configured to determine the grade of the viewer in a predetermined period on the basis of at least the satisfaction status of the grade condition by the viewer in the predetermined period (for example, every month). In this case, for example, at the timing when the period is switched (for example, the starting point of the predetermined period), the grade (and satisfaction status of the grade condition) in the previous period is cleared. Such a configuration makes it possible to promote the strengthening of the relationship between the distributor and the viewer at regular intervals.

In the present embodiment, rewarding on the basis of the grade of each of a plurality of viewers can be realized in various aspects. For example, the video distribution service controller 45 is configured to give a reward on the basis of at least the number of viewers, each of whose grade is a predetermined grade or higher. In this case, for example, the larger the number of viewers, each of whose grade is a predetermined grade or higher, the higher the value of the reward given to the distributor. Such a configuration may, for example, motivate the distributor to build a relationship of a certain strength with a large number of viewers.

Further, the video distribution service controller 45 can be configured to update the value of a predetermined parameter associated with the viewer for each distributor, which increases according to the execution of an action by the viewer on the video of the corresponding distributor. In this case, a reward may be given to the distributor on the basis of at least the value of the predetermined parameter corresponding to the distributor, of each of the plurality of viewers as well as the grade of each of the plurality of viewers. For example, the larger the total of the values of the predetermined parameters of the plurality of viewers, the more valuable the reward for the distributor. Such a configuration can promote the viewer to execute an action.

Next, a specific example as one aspect of the video distribution server 10 of the present embodiment having such a function will be described. The video distribution service in this example is configured as a live distribution service enabling users to distribute and view a live video configured of an image input via the camera of the distributor terminal 30 and an audio input via a microphone of the distributor terminal 30.

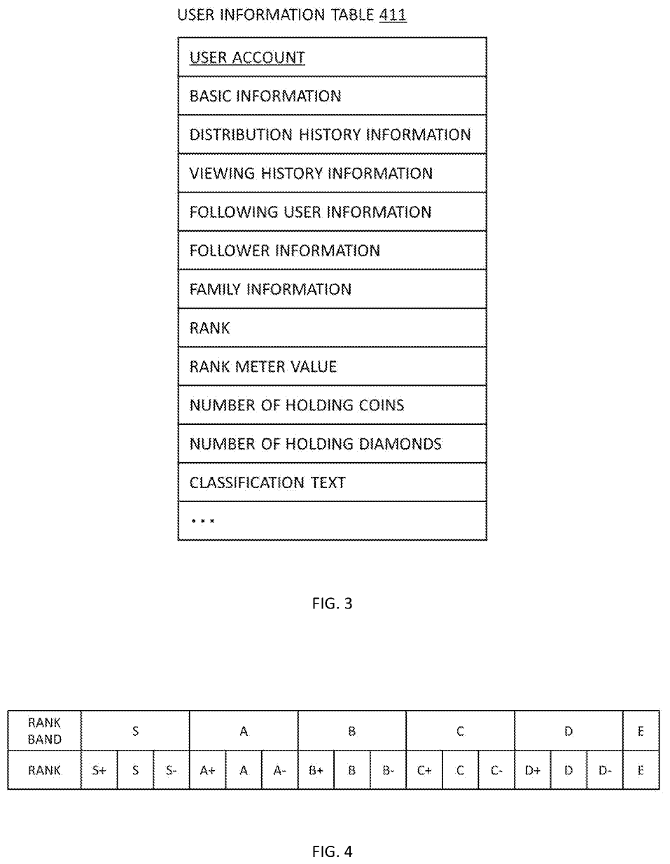

FIG. 3 illustrates the information managed in the user information table 411 in this example. The user information table 411 manages information on users of the live distribution service, and as shown in the drawing, manages the following information in associated with a “user account” that identifies an individual user. The information includes “basic information” including an account name, age, gender, area of residence, and profile information, “distribution history information” which is information on distribution history as a distributor, “viewing history information” which is information on viewing history as a viewer, “following user information” which is information on other users that this user is following, “follower information” which is information on other users (followers) who are following this user, “family information” which is information on the family that this user has joined as a family member, “rank” indicating the rank of the user as a distributor, “rank meter value” which is a parameter value for determining whether to increase or decrease the rank, “number of holding coins” indicating the number of virtual holding coins, available in the live distribution service, “number of holding diamonds” indicating the number of virtual holding diamonds, available in the live distribution service, and “classification text” which is the classification set by the user as a distributor.

In this example, the family is a community of fans who support a distributor. Users can join the family in response to an invitation from the distributor or family administrator or an approval from the distributor or family administrator for a subscription application by the user.

Further, in this example, coins are given to the user free of charge and for a fee on various occasions. For example, the user can earn coins free of charge as a reward for a login bonus or the like. Also, for example, the user can purchase coins (in real currency) for a fee.

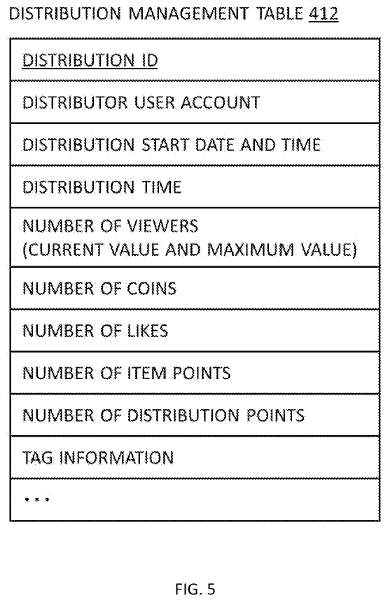

FIG. 4 is a diagram for explaining the “rank” of the distributor in this example. As shown in this example, there are six rank bands of “S”, “A”, “B”, “C”, “D” and “E”. Each of the five rank bands of “S”, “A”, “B”, “C”, and “D” has three ranks (for example, a rank with “+” added to the alphabet indicating the rank band, a rank with only the alphabet, and a rank with “−” added to the alphabet, such as “S+”, “S”, and “S−”). Further, the rank band of “E” is configured of one rank “E”. That is, in this example, there are 16 steps (3×5+1=16).

Further, in the rank bands, the “S” side is the highest and the “E” side is the lowest. Further, in the ranks in the same rank band, the “+” side is the highest rank and the “−” side is the lowest rank. In this example, the user rank is set to “D-” as an initial value.

FIG. 5 illustrates the information managed in the distribution management table 412 in this example. The distribution management table 412 manages information on individual live distributions (videos), and as shown in the drawing, manages the following information in association with a “distribution ID” that identifies individual live distributions. The information includes “distributor user account” that identifies a distributor, “distribution start date and time”, “distribution time” indicating the duration of distribution, “number of viewers (current value and maximum value)”, “number of comments” which is the number of comments input by viewers, “number of likes” which is the number of “likes” input by viewers, “number of item points” which increases according to the input of items by viewers, “number of distribution points” which is the point given for this distribution, and “tag information” which is information on the tag given to this distribution.

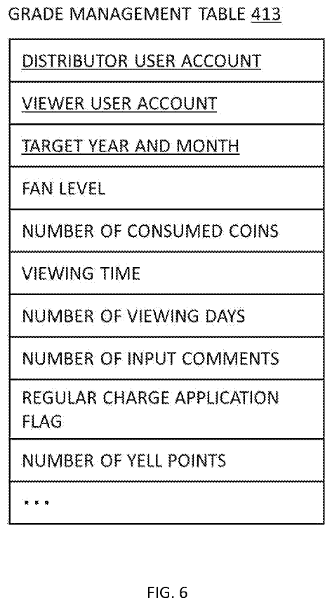

FIG. 6 illustrates the information managed in the grade management table 413 in this example. The grade management table 413 manages information on the viewer's fan level (grade) for the distributor (each distributor) in the target year and month, and as shown in the drawing, manages the following information in association with a combination of “distributor user account” that identifies a distributor, “viewer user account” that identifies a viewer, and “target year and month”. The information includes “fan level” of the corresponding viewer for the corresponding distributor in the target year and month, “number of consumed coins” of the viewer for the corresponding live distribution, “viewing time”, “the number of viewing days”, “number of input comments”, “regular charge application flag” indicating whether a regular charge for the distributor is applied to the viewer, and “number of yell points” acquired by the viewer in the corresponding live distribution. In this example, the viewer's fan level for the distributor is managed on a monthly basis.

The number of yell points is calculated using a calculation formula on the basis of the number of consumed coins, the viewing time, the number of viewing days, and the number of input comments. The larger the value of each of these parameters, the larger the value of the number of yell points.

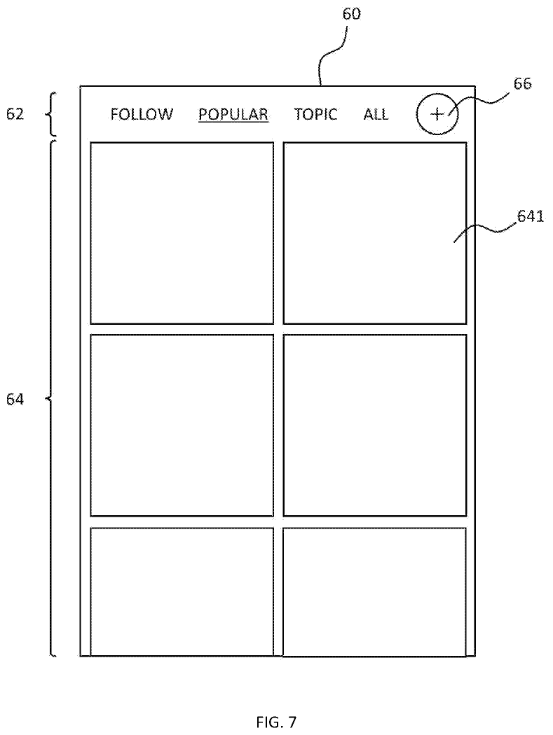

FIG. 7 illustrates a top screen 60 of the live distribution service displayed on the user terminal 30. The screen 60 is a screen that serves as a starting point for a user who uses the live distribution service. As shown in the drawing, the screen 60 includes a selection area 62 where “follow”, “popular”, “topic”, and “all” are displayed, a list display area 64 located below the area 62 and a circular distribution button 66 located in the upper right corner of the screen.

The selection area 62 is an area for selecting the display content in the list display area 64. Specifically, when “follow” is selected in the selection area 62, a list of live distributions (videos being distributed) of other users that the user follows is displayed in the list display area 64. Similarly, when “popular” is selected in the selection area 62, a list of live distributions (for example, distributions of which the number (current value) of viewers is equal to or larger than a threshold value) extracted according to a predetermined extraction condition for extracting popular live distributions is displayed in the list display area 64. When “topic” is selected in the selection area 62, a list of tags assigned to live distributions is displayed in the list display area 64 in chronological order (in order of the assigned time) together with the corresponding distribution. When “all” is selected in the selection area 62, all live distributions are displayed as a list in the list display area 64.

The top screen 60 of FIG. 7 corresponds to the case where “popular” is selected in the selection area 62. In the list display area 64 in this case, as shown in the drawing, a plurality of individual display areas 641 each displaying information on an individual live distribution are arranged in two columns. The individual display area 641 is configured so that the viewing of the corresponding distribution can be started (the play of the corresponding video is started) according to the selection by the user. The list display area 64 is configured so that the displayed individual display area 641 is switched by a flick operation or a slide operation in the vertical direction. The configuration of the list display area 64 when “follow” or “all” is selected in the selection region 62 is the same as the configuration described above when “popular” is selected.

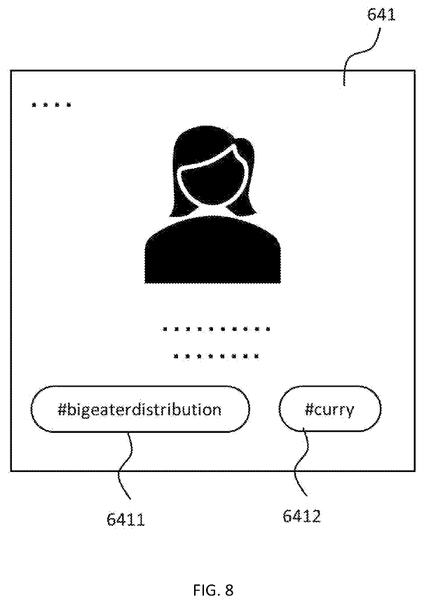

FIG. 8 illustrates the display content of the individual display area 641. The individual display area 641 displays an image preset by the distributor of the live distribution, the account name of the distributor, the number of viewers (current value), and the like. As shown in the drawing, at the lower end thereof, a first tag object 6411 and a second tag object 6412 are arranged side by side in the left-right direction. In the first tag object 6411, the classification text (managed in the user information table 411), which is the classification of the distributor set by the distributor, is displayed in a hashtag format (a format that adds “#” to the beginning of a character string) (in the example of FIG. 8, “#bigeaterdistribution” is displayed). In addition, in the second tag object 6412, the latest tag given by the viewer to the corresponding live distribution is displayed in the same hashtag format (in the example of FIG. 8, “#curry” is displayed).

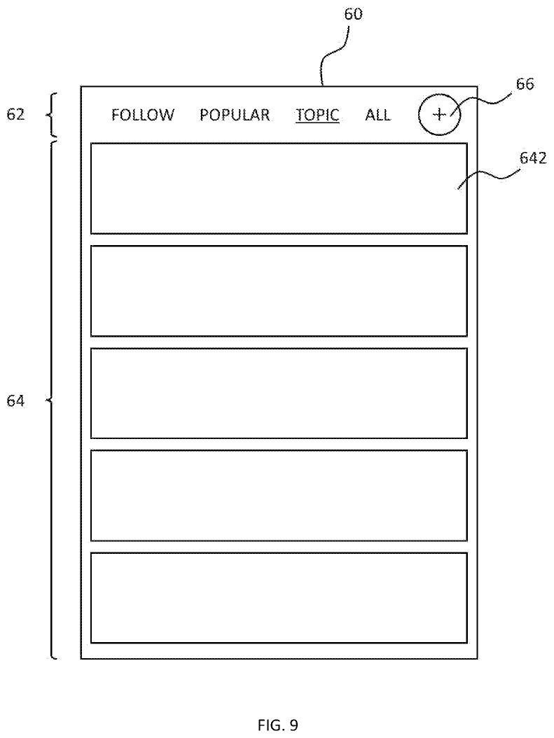

FIG. 9 illustrates the top screen 60 when “topic” is selected in the selection area 62. In this case, as shown in the drawing, the top screen 60 displays a list of tags assigned to a certain live distribution is displayed in the list display area 64 in chronological order together with the distribution. That is, in the list display area 64 when “topic” is selected in the selection area 62, a list of tags arranged in descending order of the assigned time and a list of corresponding live distributions (distributions to which the tag is assigned) are displayed.

In the list display area 64 in this case, a plurality of individual display areas 642, each displaying individual tags and information related to the corresponding live distribution, are arranged side by side in the vertical direction. When a new tag is added to a certain live distribution, the corresponding individual display area 642 is added to the top of the list display area 64.

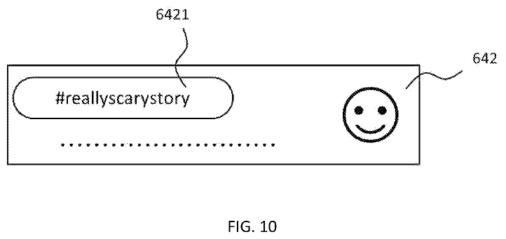

FIG. 10 illustrates the display content of the individual display area 642. As shown in the drawing, the area 642 has a tag object 6421 arranged in the upper left corner, and displays a profile image, an account name, and the like of the distributor of the corresponding live distribution (the distribution to which the tag is assigned). A link to the corresponding live distribution is set in the individual display area 642, and the user can start viewing the corresponding distribution by selecting any one of the plurality of individual display areas 642 displayed in the list display area 64.

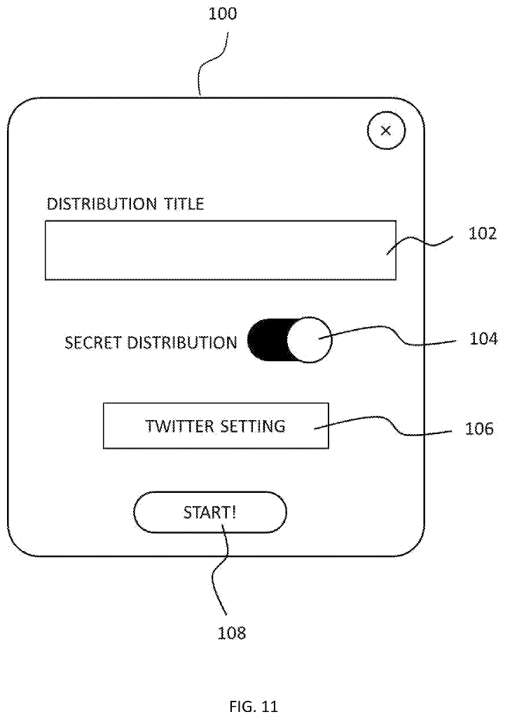

The distribution button 66 on the top screen 60 is an object for the user to perform live distribution of the video as a distributor. When the distribution button 66 is selected by the user, the distribution preparation screen 100 illustrated in FIG. 11 is displayed to be superimposed on the top screen 60. As shown in the drawing, the screen 100 includes a distribution title input area 102 for inputting a distribution title, a secret distribution setting switch 104 for setting a secret distribution mode, a twitter setting button 106 for making settings related to twitter (posting a message to SNS) performed automatically during distribution, and a distribution start button 108 displayed as “Start!”. The secret distribution is a distribution mode of live distribution that can be viewed only by new viewers (specifically, viewers whose total viewing time for a predetermined period for the corresponding distributor is less than a predetermined value).

When the distribution start button 108 is selected, live distribution is started. Specifically, transmission to the server 10, of a video configured of the image input through the camera of the user terminal 30 and the audio input via the microphone of the user terminal 30 to the server is started. In addition, a new record is created in the distribution management table 412 according to the start of live distribution.

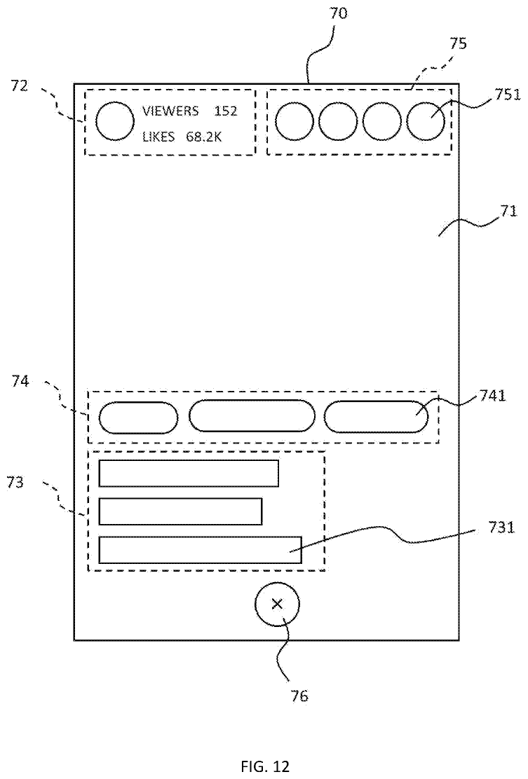

FIG. 12 illustrates a distributor screen 70 displayed on the distributor terminal 30 in response to the selection of the distribution start button 108 (that is, the start of live distribution). As shown in the drawing, the screen 70 has a video display area 71 corresponding to the entire screen, a basic information display area 72 located in the upper left corner of the screen, a comment display area 73 located in the lower left corner of the screen, a tag display area 74 located in the upper side of the area 73, a viewer information display area 75 located in the upper right corner of the screen, and a circular distribution stop button 76 located in the center of the lower end of the screen.

The video display area 71 displays a video to be live-distributed, that is, an image input via the camera of the distributor terminal 30. Since the distributor usually takes the distributor himself/herself as a subject via the in-camera or the like of the distributor terminal 30, the video to be distributed includes the image of the distributor himself/herself.

The basic information display area 72 displays the basic information of this distribution, and specifically, displays the distributor information (profile image and the like), the number of viewers (current value) of this distribution, and the number of “likes” input by the viewers for this distribution.

The comment display area 73 is an area for displaying the user comment input by the viewer or the system comment automatically input by the server 10. Specifically, in the area 73, a plurality of comment objects 731, each corresponding to an individual comment, are arranged side by side in the vertical direction. The comment display area 73 is configured so that, when a new comment is input, the corresponding comment object 731 is added to the lower side and the existing comment object 731 moves upward in order. The comment display area 73 is configured so that the displayed comment object 731 is switched by a flick operation or a slide operation in the vertical direction.

The tag display area 74 displays information on the tags assigned to the distribution. Specifically, in the area 74, a plurality of tag objects 741 each corresponding to an individual tag are arranged side by side in the left-right direction.

The viewer information display area 75 displays information on a plurality of viewers who are viewing the corresponding live distribution. Specifically, in the area 75, a plurality of icon objects 751 each corresponding to a viewer are arranged side by side in the left-right direction. The object 751 has a circular shape and displays a profile image of the corresponding viewer. The plurality of icon objects 751 are arranged in an order according to a predetermined rule, and for example, the viewer having a large number of yell points described above is arranged on the left side.

The distribution stop button 76 is an object for the distributor to stop the live distribution. When the distribution stop button 76 is selected by the distributor, live distribution (transmission of a video from the distributor terminal 30 to the server 10) is stopped.

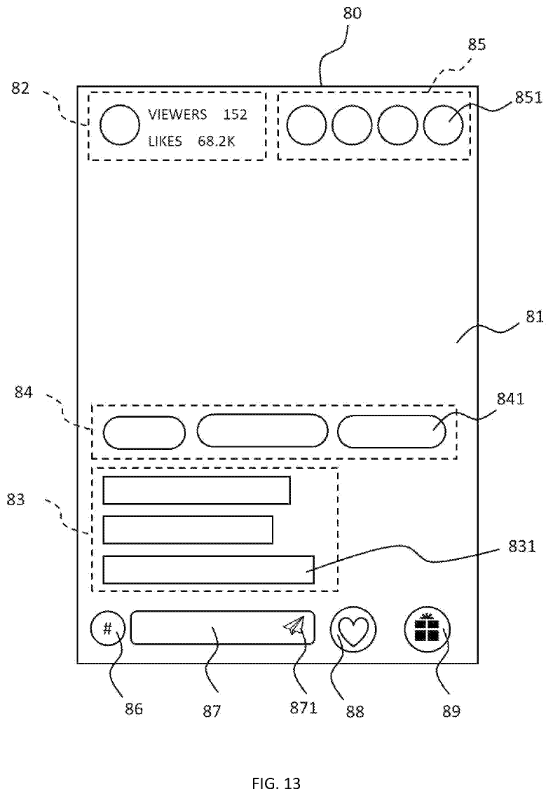

FIG. 13 illustrates a viewer screen 80 displayed on the viewer terminal 30. For example, when a certain live distribution is selected by the viewer via the list display area 64 or the like of the top screen 60, the viewer screen 80 for viewing the selected distribution is displayed on the viewer terminal 30. As shown in the drawing, the screen 80 has a video display area 81, a basic information display area 82, a comment display area 83, a tag display area 84, and a viewer information display area 85, similarly to the distributor screen 70 described above. Further, the viewer screen 80 includes, at the lower end of the screen, an input mode switching button 86, a comment input area 87, a “like” button 88 on which a heart mark is displayed, and an item input button 89 on which a gift pattern is displayed.

The comment input area 87 is an area for the viewer to input a comment or a tag. While the input mode switching button 86 is in the non-selected state, the comment input area 87 is in a normal comment input mode. In the comment input mode, when a transmission object 871 arranged at the right end of the comment input area 87 is selected, a character string input in the area 87 is transmitted as a user comment, and comment objects 731 and 831 corresponding to the user comment are added to the comment display areas 73 and 83 of the distributor screen 70 and the viewer screen 80 of the corresponding distributor terminal 30 (the user terminal 30 of the distributor of the live distribution being viewed) and the viewer terminals 30 (user terminals 30 of a plurality of viewers of the live distribution being viewed). In the comment objects 731 and 831 corresponding to the user comment, the content (character string) of the comment is displayed together with the account name of the viewer who input the comment. Further, when the user comment is transmitted, the server 10 updates (adds 1) the number of comments of the corresponding record in the distribution management table 412. Further, when the user comment is transmitted, the server 10 updates (adds 1) the number of input comments of the corresponding record in the grade management table 413.

When the input mode switching button 86 is selected, the comment input area 87 is in a tag input mode. In the tag input mode, when the transmission object 871 is selected, the character string input in the comment input area 87 is transmitted as a tag, and the tag is assigned (associated with) to the live distribution. In this example, the viewers who can input tags are limited to the family members of the corresponding distributor. Specifically, the input mode switching button 86 on the viewer screen 80 can be selected (enabled) when the viewer is a family member of the distributor and cannot be selected (disabled) when the viewer is not a family member of the distributor. Further, in this example, the number of tags that can be assigned to one live distribution in a predetermined period is limited, and specifically, the number of tags that can be assigned in 5 minutes is three.

When the tag is added, the corresponding tag objects 741 and 841 are added in the tag display areas 74 and 84 of the corresponding distributor screen 70 and viewer screen 80. The tag objects 741 and 841 are arranged side by side in the tag display areas 74 and 84 so that the left side is newer (the assigned time is later). Therefore, the tag objects 741 and 841 corresponding to the newly added tag are added to the left end in the tag display areas 74 and 84. After 5 minutes have passed since the corresponding tag was added, the tag objects 741 and 841 are deleted (for example, they disappear with an animation effect of moving to the right).

The tag objects 741 and 841 in this example display the content of the tag in the hashtag format in which “#” is added to the beginning of the character string. For example, when the content of the tag is “Tokyo sightseeing”, “#tokyosightseeing” is displayed in the tag objects 741 and 841. The length of the tag objects 741 and 841 in the left-right direction is automatically adjusted according to the length of the character string to be displayed.

Further, when the tag is added, comment objects 731 and 831 corresponding to a system comment notifying of the addition of the tag are added in the comment display areas 73 and 83 of the corresponding distributor screen 70 and viewer screen 80. In the comment objects 731 and 831 corresponding to the system comment, the content of the added tag is displayed together with the account name of the viewer who added (input) the tag. For example, a comment “xx tagged “#tokyosightseeing” to the distribution” is displayed. Further, when the tag is added, the tag information of the corresponding record in the distribution management table 412 is updated.

The like button 88 is an object for the viewer to input a “like” to the distributor (live distribution). When the button 88 is selected by the viewer, “like” is input, and the comment objects 731 and 831 corresponding to a system comment notifying of the input of “like” are added in the comment display areas 73 and 83 of the corresponding distributor screen 70 and viewer screen 80. In the comment objects 731 and 831 corresponding to the system comment, a text indicating the input of “like” is displayed together with the account name of the viewer who has input the “like”. Further, when “like” is input, a predetermined visual effect (for example, an animation effect that a heart-shaped object is displayed so as to move from the lower side to the upper side of the screen) is added in the video display areas 71 and 81 of the distributor screen 70 and the viewer screen 80. Further, when “like” is input, the server 10 updates (adds 1) the “number of likes” of the corresponding record in the distribution management table 412.

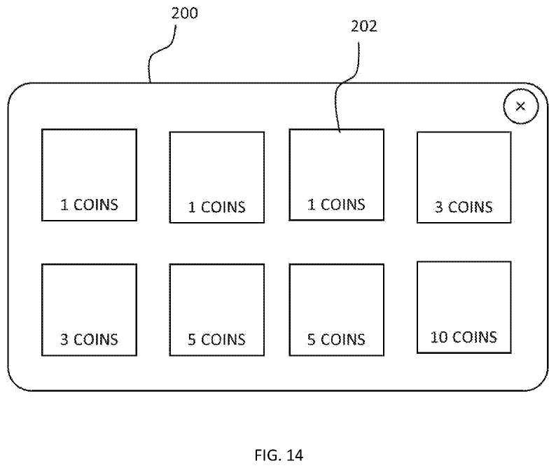

The item input button 89 is an object for the viewer to input an item. When the button 89 is selected by the viewer, the item selection screen 200 illustrated in FIG. 14 is displayed to be superimposed on the viewer screen 80. As shown in the drawing, the screen 200 displays a list of a plurality of individual display areas 202, each displaying information on an item. The individual display area 202 displays an image corresponding to the item and the number of coins required for inputting the item.

In this example, a plurality of items that can be input by the viewer are determined in advance, and the number of coins as the price (which can also be called value or reward) is set in advance for each item. The item selection screen 200 displays a list of a plurality of items that can be input. When a certain item is selected by the viewer via the item selection screen 200, the selected item is input.

When an item is input, the comment objects 731 and 831 corresponding to a system comment notifying of the input of the item are added in the comment display areas 73 and 83 of the corresponding distributor screen 70 and viewer screen 80. In the comment objects 731 and 831 corresponding to the system comment, the name of the input item is displayed together with the account name of the viewer who input the item. Further, when an item is input, a visual effect corresponding to the input item is added in the video display areas 71 and 81 of the corresponding distributor screen 70 and viewer screen 80. Further, when an item is input, the server 10 assigns a number of item points (for example, the larger the number of coins, the larger the number of points) corresponding to the number of coins of the input item to this distribution. Specifically, in the distribution management table 412, the number of points corresponding to the number of coins is added to the number of item points of the corresponding record. When an item is input, the server 10 subtracts the number of coins of the input item from the number of holding coins in the corresponding record (record of the viewer who input the item) in the user information table 411. When an item is input, the server 10 adds the number of coins of the input item to the number of consumed coins of the corresponding record in the grade management table 413.

In this example, a viewer to whom regular charge for the corresponding distributor (the distributor of the live stream being viewed) is applied can input some items any number of times without consuming individual coins. For such items, for example, a note that it is not necessary to consume individual coins due to regular charge is displayed in the individual display area 202 of the item selection screen 200. Further, in this example, when the regular charge is applied, the number of coins corresponding to the amount of the regular charge is added to the number of consumed coins every month in the corresponding record of the grade management table 413.

Further, when the viewer newly starts viewing (enters a live distribution room), the comment objects 731 and 831 corresponding to the system comment notifying of the viewer's entry are added in the comment display areas 73 and 83 of the corresponding distributor screen 70 and viewer screen 80. In the comment objects 731 and 831 corresponding to the system comment, the account name and the like of the user who has started viewing (has entered the room) is displayed. Further, when the current viewing is the first viewing on the day of the live distribution of the corresponding distributor, the server 10 updates (adds 1) the number of viewing days of the corresponding record in the grade management table 413.

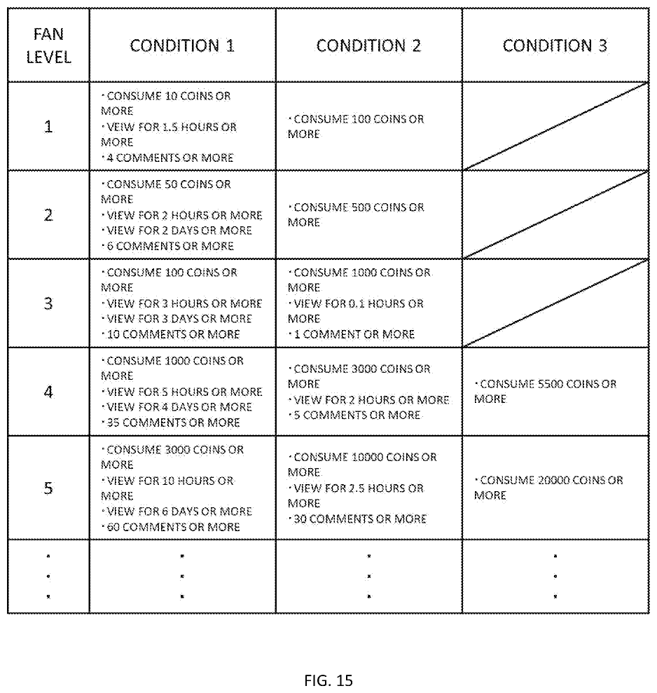

Here, the operation related to the management of the fan level of the viewer with respect to the distributor will be described. FIG. 15 is a diagram for explaining the condition (grade condition) of each of the plurality of fan levels in this example. As shown in the drawing, in this example, two or three conditions are set for each fan level, and a user who satisfies any one of these two or three conditions has a corresponding fan level (the level goes up). For example, the fan level of “1” includes two conditions including condition 1 that “consumes 10 coins or more, views for 1.5 hours or more, and inputs 4 comments or more”, and condition 2 that “consumes 100 coins or more”. A user who satisfies any one of these two conditions becomes a viewer with the fan level of “1”. Further, for example, the fan level of “4” includes three conditions including condition 1 “consume 1000 coins or more, view for 5 hours or more, view for 4 days or more, and input 35 comments or more”, condition 2 that “consume 3000 coins or more, view for 2 hours or more and input 5 comments or more” and condition 3 that “consume 5500 coins or more”. A user who satisfies any one of these three conditions becomes a viewer with the fan level of “4”.

Such fan level is determined in real-time during live distribution. Specifically, during live distribution, the server 10 updates the number of consumed coins, the viewing time, the number of viewing days, and the number of input comments in the grade management table 413 for each viewer in real-time, and determines whether the fan level has been raised on the basis of these pieces of information. As the fan level rises, the value of the fan level of the corresponding record in the grade management table 413 is updated.

In this example, in the regular charge to the distributor, an amount corresponding to 6000 coins is charged every month. Therefore, the viewer to whom the regular charge is applied immediately satisfies the condition 3 (consumes 5500 coins or more) of the fan level “4” illustrated in FIG. 15.

In this example, a decoration corresponding to the fan level of the viewer is made on the comment objects 731 and 831 corresponding to the viewer's actions (specifically, entry (start of viewing), comment, tag, like, and item input). For example, an icon corresponding to the fan level of the viewer is added to the comment objects 731 and 831, and a character color corresponding to the fan level is applied.

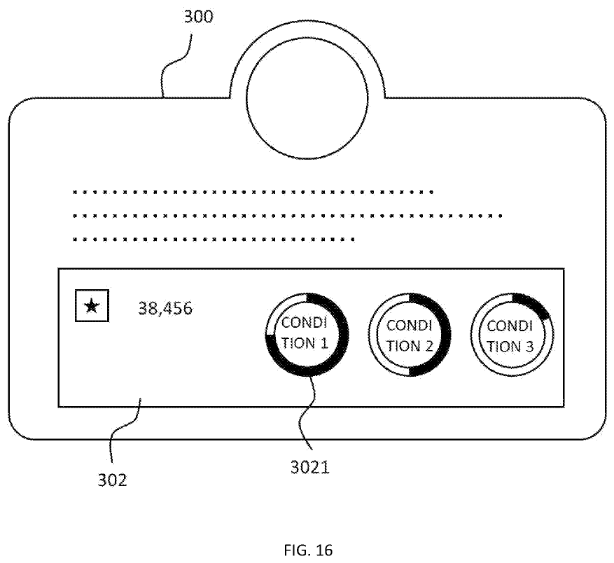

Further, in this example, the satisfaction status of the condition of the fan level of each viewer is displayed via the viewer information display areas 75 and 85 of the distributor screen 70 and the viewer screen 80. FIG. 16 illustrates a viewer information display screen 300 that is displayed to be superimposed on the distributor screen 70 and the viewer screen 80 according to the selection of the icon objects 751 and 851 of the viewer information display areas 75 and 85. As shown in the drawing, the screen 300 has a fan level information display area 302 that displays a profile image, an account name, a profile, and the like of the corresponding viewer, and displays information on the fan level in the lower part thereof.

As shown in the drawing, the fan level information display area 302 displays an icon image corresponding to the current level, the number of yell points, and the like, and condition satisfaction objects 3021 that display the satisfaction status of each of the two or three conditions for advancing to the next (one higher) fan level are arranged side by side in the left-right direction in the right part thereof. In the viewer information display screen 300 of FIG. 16, three condition satisfaction objects 3021 corresponding to each of the three conditions 1 to 3 are arranged. However, when there are two conditions corresponding to the next fan level, two condition satisfaction objects 3021 are arranged side by side in the left-right direction.

The condition satisfaction object 3021 displays the degree of satisfaction of the condition in a ring portion, and specifically, the degree of satisfaction is displayed in the form of a circular progress bar extending clockwise from the 12 o'clock position as the degree of satisfaction of the condition increases. The degree of satisfaction of the condition is set as a ratio of the current value to the condition value (maximum value) of the parameter (the number of consumed coins, the viewing time, the number of viewing days, or the number of input comments) corresponding to the condition. The user can know the current fan level of each viewer including other users and the outline of the satisfaction status of the condition for advancing to the next fan level through the condition satisfaction detail screen 400.

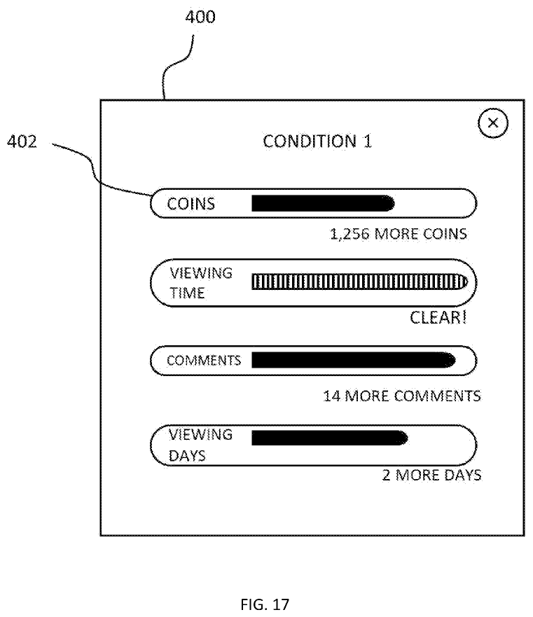

In this example, in a state where the corresponding user's own icon object 851 is selected in the viewer information display area 85 of the viewer screen 80 and the viewer information display screen 300 for displaying the user's own information is displayed, when the fan level information display area 302 is selected, the condition satisfaction detail screen 400 illustrated in FIG. 17 is displayed. As shown in the drawing, the screen 400 has a sub-condition indicator 402 that displays the satisfaction degree of the corresponding sub-condition for each condition corresponding to the next fan level.

The sub-condition indicator 402 displays the degree of satisfaction in the form of a bar-shaped progress bar that extends to the right as the degree of satisfaction of the condition increases. Further, a text regarding the degree of satisfaction of the corresponding sub-condition is displayed on the lower right side of the sub-condition indicator 402. Specifically, a text regarding the quantity required to satisfy the sub-condition (for example, “1,256 more coins”) is displayed, or if the sub-condition is already satisfied, the text “CLEAR!” is displayed.

The “condition 1” in the example of FIG. 17 has four sub-conditions, that is, a sub-condition regarding the number of coins, a sub-condition regarding the viewing time, a sub-condition regarding the number of comments, and a sub-condition regarding the number of viewing days. Four sub-condition indicators 402 corresponding to the four sub-conditions are arranged side by side in the vertical direction. The condition satisfaction detail screen 400 is configured so that the displayed conditions are switched by a flick operation or a slide operation in the left-right direction. The user can know the details of the satisfaction status of the condition for the user himself/herself to advance to the next fan level through the condition satisfaction detail screen 400.

The operation related to the management of the fan level of the viewer with respect to the distributor has been described above. Next, the operation when the distributor ends the live distribution will be described. As described above, when the distributor selects the distribution stop button 76 on the distributor screen 70, the live distribution ends. When the live distribution ends, the server 10 calculates and sets the number of distribution points for the distribution. In this example, the number of distribution points is calculated on the basis of the number of viewers (maximum value), the number of likes, the number of comments, and the number of item points. The number of distribution points increases as the number of viewers (maximum value), the number of likes, the number of comments, and the number of item points increase. The calculated number of distribution points is set in the corresponding record in the distribution management table 412.

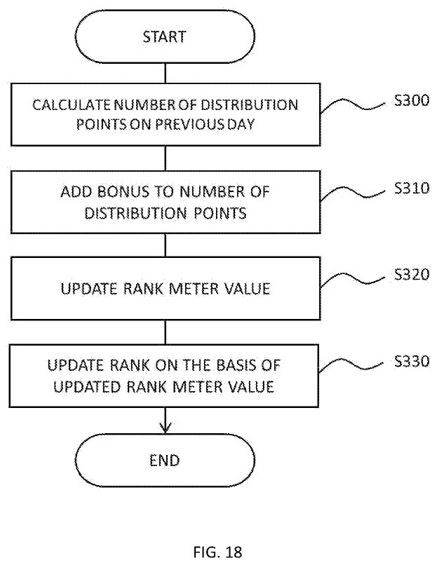

The operation when the distributor ends the live distribution has been described above. Next, the operation when determining the rank of the distributor will be described. In this example, the rank of the day is determined (updated) on the basis of the number of distribution points acquired by the user on the previous day. FIG. 18 is a flowchart illustrating processes executed by the server 10 when updating the rank of each user. These processes are performed daily at midnight (for example, 3 AM daily).

First, as shown in the drawing, the server 10 calculates the number of distribution points acquired by each user on the previous day (step S300). The number of distribution points acquired by a specific user on the previous day is calculated by referring to the distributor user account, the distribution start date and time, and the number of distribution points in the distribution management table 412. When the user performs a plurality of distributions in one day, the numbers of distribution points acquired in the plurality of distributions are added up.

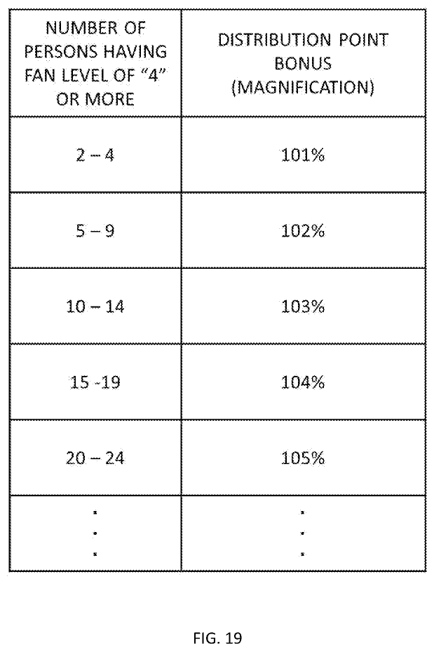

When the number of distribution points on the previous day of each distributor is calculated in this way, the server 10 subsequently adds a bonus to the number of distribution points (step S310). Specifically, in this example, a bonus is added to the number of distribution points according to the number of “special fans” whose fan level is “4” or higher. FIG. 19 illustrates the correspondence between the number of special fans and the distribution point bonus (magnification). In this example, as shown in the drawing, when the number of special fans is 2 to 4, the number of distribution points is 101% (multiplied by 1.01) as a distribution point bonus. In other words, if the number of special fans is 2 to 4, 1% of the calculated number of distribution points will be added as a bonus. Similarly, when the number of special fans is 5 to 9, the distribution point bonus (magnification) is 102%, and then the distribution point bonus (magnification) increases as the number of special fans increases, which is advantageous for the distributor.

Further, as described above, in this example, the viewer to which the regular charge is applied is automatically a special fan having a fan level of “4” or higher, so that it is advantageous for the distributor to acquire many viewers to which the regular charge is applied.

Further, in this example, a bonus is added to the distribution points according to the total of the numbers of yell points of the plurality of viewers. For example, if the total number of yell points is 5000 points or more, a bonus of 500 points will be added to the distribution points, and if the total value of the number of yell points is 10,000 points or more, a bonus of 1000 points will be added to the distribution points. The bonus increases as the number of yell points increases, which is advantageous for the distributor. In another example of the present embodiment, the bonus of distribution points based on the number of yell points is not applied, and only the bonus of distribution points based on the number of special fans may be applied.

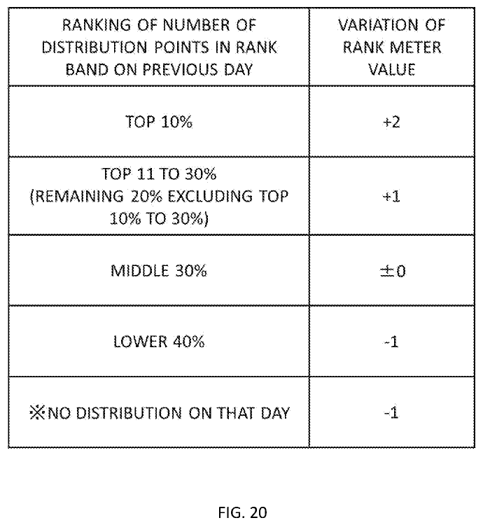

When the bonus for the number of distribution points is added in this way, the server 10 then updates the rank meter value of each user (step S320). FIG. 20 is a diagram for explaining the update rule of the rank meter value. As shown in the drawing, in this example, the rank meter value varies on the basis of the ranking of the number of distribution points of each user on the previous day in the rank band to which the user belongs.

Specifically, as shown in FIG. 20, the rank meter value update rule is as follows. First, when the ranking of the number of distribution points in the rank band is included in the top 10%, the variation of the rank meter value is “+2” (increased by 2 points). Similarly, the variation is “+1”, when the ranking is included in the top 11% to 30% (the remaining 20% excluding the top 10% to the top 30%), the variation is “±0” (not changed) when the ranking is the middle 30% (the top 31% to 60%), and the variation is “−1” (decreased by 1 point) when the ranking is included in the lower 40%. If no distribution is performed in the previous day, the variation of the rank meter value will be “−1” regardless of the ranking in the rank band.

In step S320, the rank meter value of each user is updated according to the update rule illustrated in FIG. 20.

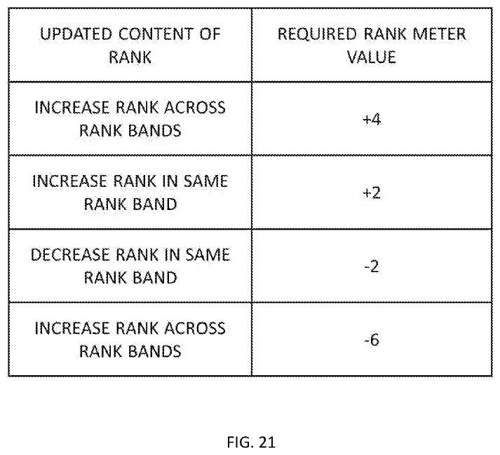

Returning to the flowchart of FIG. 18, when the rank meter value of each user is updated, the server 10 then updates the rank on the basis of the updated rank meter value (step S330). FIG. 21 is a diagram for explaining the correspondence between the updated content of the rank and the required rank meter value. As shown in the drawing, first, the rank meter value required for increasing the rank across rank bands (in other words, for a user to move up in the ranks from the highest rank in each rank band) is +4. That is, when the rank meter value reaches+4, the user belonging to the highest rank (for example, A+) in each rank band moves up in the ranks to the lowest rank (for example, S−) in the rank band immediately above. Further, the rank meter value required for increasing the rank within the same rank band (in other words, for a user to move up in the ranks from the middle or lowest rank in each rank band) is +2. That is, when the rank meter value reaches+2, the user belonging to the middle or lowest rank (for example, B or B−) in each rank band moves up in the ranks to a rank (for example, B+ or B) immediately above in the same rank band.

Similarly, as illustrated in FIG. 21, the rank meter value required for decreasing the rank within the same rank band (in other words, for a user to move down in the ranks from the highest or middle rank in each rank band) is −2. That is, when the rank meter value reaches −2, the user belonging to the highest or middle rank (for example, B+ or B) in each rank band moves down in the ranks to a rank (for example, B or B−) immediately below in the same rank band. In addition, the rank meter value required for decreasing the rank across rank bands is −6. That is, when the rank meter value reaches −6, the user belonging to the lowest rank (for example, A−) in each rank band moves down in the ranks to the highest rank (for example, B+) in the rank band immediately below. As described above, in this example, the rank meter value required for increasing or decreasing the rank across the rank bands is larger than that required for increasing or decreasing the rank within the same rank band. As a result, increasing or decreasing the rank rapidly in a short period of time is suppressed.

In step S330, the rank based on the rank meter value is updated according to the correspondence illustrated in FIG. 21. The rank meter value of the user whose rank has been updated (the user whose rank has been increased/decreased) is cleared to 0.

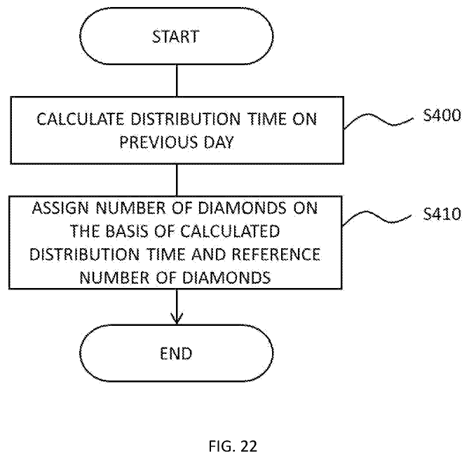

The operation for determining the rank of the distributor has been described above. Next, the operation when giving a diamond to the user will be described. In this example, a diamond, which is a reward for the user as a distributor, is given on the basis of the distribution time of the previous day and the rank (the rank on the previous day). FIG. 22 is a flowchart illustrating processes executed by the server 10 when assigning a diamond to each distributor. These processes are executed at midnight every day, for example, is executed at a time (for example, 0 o'clock AM every day) before the processing executed when updating the rank of each user illustrated in FIG. 18.

First, the server 10 calculates the distribution time of each user on the previous day as shown in the drawing (step S400). The distribution time of the previous day of a specific user is specifically calculated by referring to the distributor user account, the distribution start date and time, and the distribution time in the distribution management table 412. When the user performs a plurality of distributions in one day, the distribution times of the plurality of distributions are added up.

Subsequently, the server 10 assigns each user a number of diamonds based on the calculated distribution time and a reference number of diamonds (step S410). Specifically, each user is given a number of diamonds obtained by multiplying the calculated distribution time by the reference number of diamonds. The reference number of diamonds is set in advance for each rank so that the higher the rank, the larger the reference number of diamonds, and the reference number of diamonds corresponding to the rank of each user on the previous day is applied. When a diamond is given to the user, the number of holding diamonds in the corresponding record in the user information table 411 is updated. In this example, diamonds can be exchanged with coins or real currency.

In the above example, the condition corresponding to the fan level may vary on the basis of the distributor information on the distributor, the viewer information on the viewer, the combination information on the combination of the distributor and the viewer, or the like. For example, the lower the rank of the distributor, the easier it is to satisfy the condition corresponding to the fan level (for example, the lower the condition value). Further, for example, the condition corresponding to the fan level varies depending on the viewer's area of residence (for example, the condition of the viewer who lives in a specific residential area is easily satisfied). Further, for example, the condition corresponding to the fan level is easily satisfied in the target year and month when the live distribution of the corresponding distributor is first viewed.

In the above-mentioned example, a predetermined higher fan level may be invalidated for a certain period from the start point of each month, and may be effective from a specific timing in the middle of the month. In this case, for example, a viewer who satisfies the condition corresponding to the fan level effective at a specific timing (for example, 15th) of each month before the fan level becomes effective is not raised to the fan level until the fan level becomes effective (until a specific timing is reached). In this way, it is possible to prevent the number of high-ranking fan-level viewers from increasing excessively early in each month, and the withering of other general viewers.

In the above example, a bonus is added to the number of distribution points according to the number of “special fans” whose fan level is “4” or higher, but the reward according to the number of special fans is an example of a reward based on the fan level of each of a plurality of viewers, and in another example of the present embodiment, other rules may be applied. For example, a bonus may be added to the number of distribution points according to the total value of the fan levels.

Further, the addition of the bonus to the number of distribution points is an example of the reward for the distributor, and in another example of the present embodiment, various rewards may be given to the distributor on the basis of the fan level of each of the plurality of viewers. For example, as a reward for the distributor, a bonus for the reference number of diamonds may be added, or the right to participate in a special event may be given.

In the above-described example, a live distribution service enabling users to distribute and view a live video configured of an image input via the camera of the distributor terminal 30 and an audio input via a microphone of the distributor terminal 30 is provided. However, in another example of the present embodiment, an on-demand-type video distribution service that stores a video provided by the distributor in advance and distributes the video individually in response to the request from the viewer is provided. Even in this case, the fan level of the viewer for the distributor (video provider) is managed, and the reward may be given to the distributor on the basis of at least the fan level of each of the plurality of viewers.

The video distribution server 10 of the present embodiment described above determines the grade (for example, a fan level) of the viewer with respect to the distributor on the basis of the satisfaction status of the grade condition, and the reward (for example, the addition of a bonus to the number of distribution points) is given to the distributor on the basis of the grade of each of the plurality of viewers (for example, the number of special fans whose fan level is “4” or higher). Therefore, for example, the upgrade of the viewer is a direct benefit to the distributor and the distributor is motivated to strengthen the relationship with the viewer. That is, the video distribution server 10 can promote the strengthening of the relationship between the distributor and the viewer.

The processes and procedures described in the present specification are implemented by software, hardware, or any combination thereof, in addition to those expressly described. For example, the processes and procedures described in the present specification are realized by implementing logic corresponding to the processes and procedures on a medium such as an integrated circuit, a volatile memory, a non-volatile memory, or a magnetic disk. Further, the processes and procedures described in the present specification can be implemented as a computer program corresponding to the processes and procedures and executed by various computers.

Even if it is explained that the processes and procedures described in the present specification are executed by a single device, software, component, module, such processes or procedures may be executed by multiple devices, multiple pieces of software, multiple components, and/or multiple modules. The software and hardware components described in the present specification can also be realized by integrating them into fewer components or by breaking them down into more components.

In the present specification, even when the components of the invention are described as either singular or plural, or the components of the invention are described without limitation to either singular or plural, the components may be either singular or plural except that they should be understood separately in the context.

What is claimed is:

1. A system, comprising one or more computer processors that execute machine-readable instructions to perform:
determining a grade of each of a plurality of viewers with respect to a distributor of a video on the basis of at least a satisfaction status by each of the plurality of viewers of a grade condition corresponding to each of a plurality of grades; and
assigning a reward to the distributor on the basis of at least the grade of each of the plurality of viewers with respect to the distributor.

2. The system according to claim 1, wherein the grade condition includes a condition that is satisfied according to execution of an action on the video of the distributor.

3. The system according to claim 1, wherein the grade condition includes a condition that is satisfied according to application of regular charge to the distributor.

4. The system according to claim 3, wherein
the one or more computer processors further perform controlling execution of a predetermined action by each of the plurality of viewers on the video of the distributor; and
the predetermined action is executed on the basis of separate charge or the regular charge.

5. The system according to claim 1, wherein the grade condition is configured to vary on the basis of at least one of distributor information on the distributor, viewer information on each of the plurality of viewers, and combination information on each combination of the distributor and the plurality of viewers.

6. The system according to claim 1, wherein
the one or more computer processors further perform presenting a viewer screen for viewing the video of the distributor to each of the plurality of viewers; and
the viewer screen is configured to display the satisfaction status of the grade condition of at least some of a viewer group viewing the video of the distributor.

7. The system according to claim 6, wherein the viewer screen is configured to display, with a first detail level, the satisfaction status of the grade condition of a first viewer other than a second viewer to which the viewer screen is presented, and display, with a second detail level that is more detailed than the first detail level, the satisfaction status of the grade condition of the second viewer.

8. The system according to claim 1, wherein the determining includes determining the grade of each of the plurality of viewers in a predetermined period on the basis of at least the satisfaction status by each of the plurality of viewers of the grade condition in the predetermined period.

9. The system according to claim 1, wherein the assigning includes assigning the reward on the basis of at least the number of viewers having a predetermined grade or higher among the plurality of viewers.

10. The system according to claim 1, wherein
the one or more computer processors further perform updating a value of a predetermined parameter for each of distributors associated with the plurality of viewers, the value increasing according to execution of an action by each of the plurality of viewers on the video of the corresponding distributor; and
the assigning includes assigning the reward to the distributor on the basis of at least the value of the predetermined parameter corresponding to the distributor of each of the plurality of viewers in addition to the grade of each of the plurality of viewers.

11. A method performed by one or more computers, comprising:
determining a grade of each of a plurality of viewers with respect to a distributor of a video on the basis of at least a satisfaction status by each of the plurality of viewers of a grade condition corresponding to each of a plurality of grades; and
assigning a reward to the distributor on the basis of at least the grade of each of the plurality of viewers with respect to the distributor.

12. A non-transitory computer-readable medium including a program, the program causing one or more computers to execute:
determining a grade of each of a plurality of viewers with respect to a distributor of a video on the basis of at least a satisfaction status by each of the plurality of viewers of a grade condition corresponding to each of a plurality of grades; and
assigning a reward to the distributor on the basis of at least the grade of each of the plurality of viewers with respect to the distributor.
